(19) United States
(12) Patent Application Publication
(10) Pub. No.: US 2004/0042032 A1
(43) Pub. Date: Mar. 4, 2004

(54) Copy document production

(76) Inventor: John D. Laughlin, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/229,616

(22) Filed: Aug. 27, 2002

(51) Int. Cl. G06F 3/12; G06F 13/00; G06F 15/00

(52) U.S. Cl. 358/1.15; 358/1.18; 358/3.28

(57) ABSTRACT

Distinguishing one produced document from another. In one embodiment a command is received to produce a document, production options are set for a copy production service that differ from production options set for a primary production service, the primary production service is directed to produce the document according to the production options set for the primary production service, and the copy production service is directed to produce the document according to the production options set for the copy production service. It is expected that the production options set for the copy production service will cause the copy production service to produce the document such that the document by the copy production service differs visually from the same document produced by the primary production service.

### FIELD OF THE INVENTION

The present invention generally relates to producing electronic documents, and, more specifically, to automatically distinguishing one produced document from another.

### BACKGROUND

Document production in a typical computer system is controlled by the operating system. When using a GUI (Graphical User Interface) operating system, such as Windows® from Microsoft Corporation or Macintosh® from Apple Computer, Inc., a user issues a production command either through a menu option or by using a mouse to select a designated icon on a button bar. Document production can take a number of forms. The use of a production service such as a laser printer to print the document is common. Document production, however, can require a finishing service such as a binder, sorter, and/or folder. Document production may also be completed through the use of a programming service such as an e-mail client, facsimile software, or programming capable of electronically archiving the document.

Drivers are typically supplied to computer users either by the vendor of the production service or by the vendor of the operating system. A driver is responsible for providing an interface enabling a user to select production options for a particular production service. Since the sophistication of a user interface can help sell production services, vendors continue to produce evermore sophisticated drivers. For example, some of the production options currently available for printers include: printing multiple copies of a document; printing the pages in a document in reverse order; printing multiple pages of a document on a single page of paper; landscape and portrait printing; printing on different page sizes; printing labels; duplex printing where both sides of a page are printed; and printing with watermarks. Similar production options are available when faxing, e-mailing, or archiving a document.

Once a production command is issued, a driver specific to a selected production service formats the electronic document for the selected service. The driver then directs the formatted document to that service for production. It is often advantageous to create a copy of a produced document to maintain business or personal records. This can be accomplished, for example, by incrementing the “copy” count by one before printing. In such a case, the copy of a document is identical to the original. It is often useful to distinguish copies from originals. Existing document production software and related programming such as drivers, however, do not allow the user to automatically distinguish one produced document from another.

### SUMMARY

Accordingly, embodiments of the present invention produce, at a user's request, document copies that can be distinguished from the original. In one embodiment a command is received to produce a document, production options are set for a copy production service that differ from production options set for a primary production service, the primary production service is directed to produce the document according to the production options set for the primary production service, and the copy production service is directed to produce the document according to the production options set for the copy production service. It is expected that the production options set for the copy production service will cause the copy production service to produce the document such that the document produced by the copy production service differs visually from the same document produced by the primary production service.

### DESCRIPTION OF THE DRAWINGS

FIG. 1 is a schematic representation of a computer network in which various embodiments of the present invention may be incorporated.

FIG. 2 is a block diagram of the network of FIG. 1 illustrating the logical program components according to an embodiment of the present invention.

FIG. 3 is a block diagram illustrating the logical components of the drivers and of the production coordinator according to an embodiment of the present invention.

FIG. 4 is a flow diagram illustrating primary and copy document production according to an embodiment of the present invention.

FIGS. 5-10 are exemplary screen views of a series of interfaces enabling a user to select a primary production service, a copy production service, and production options for each.

### DETAILED DESCRIPTION

Introduction: Electronic documents can be produced in a variety of ways. For example, a document can be printed and bound. It can be faxed or e-mailed to a specified location. The document can even be electronically archived. When producing a document, it is often desirable to create a copy. It is expected that various embodiments of the present invention will enable the production of a copy that can be distinguished from the original.

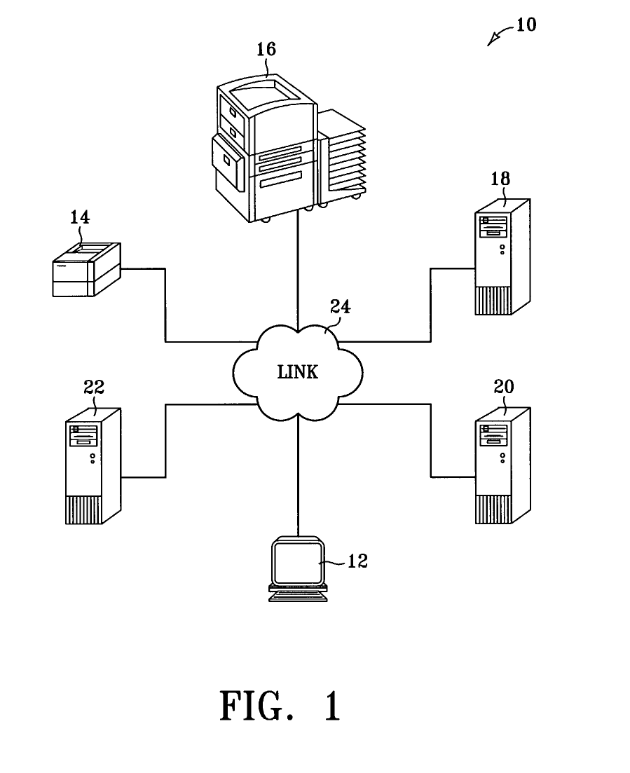

Although the various embodiments of the invention disclosed herein will be described with reference to the computer network 10 shown schematically in FIG. 1, the invention is not limited to use with network 10. The invention may be implemented in or used with any computer system in which it is necessary or desirable to produce electronic documents. The following description and the drawings illustrate only a few exemplary embodiments of the invention. Other embodiments, forms, and details may be made without departing from the spirit and scope of the invention, which is expressed in the claims that follow this description.

Referring to FIG. 1, network 10 represents generally any local or wide area network in which a variety of different devices are linked. Network 10 includes computer 12, printer 14, printing/finishing device 16, and servers 18-22, interconnected by link 24. Printer 14, finisher 16, and servers 18-22 represent various production services. Each server 18-22 includes a production service in the form of programming capable of faxing, e-mailing, or archiving an electronic document. Computer 12 represents generally any computing device capable of enabling a user to issue a production command for a selected document, formatting the selected document for a specified production service, and directing the formatted document to that service for production.

Link 24 represents generally a cable, wireless, or remote connection via a telecommunication link, an infrared link, a radio frequency link, or any other connector or system that provides electronic communication between components 12-22. Link 24 may represent an intranet, the Internet, or a combination of both. The path followed by link 24 between components 12-22 represents the logical communication path between the components, not necessarily the physical path. Components 12-22 can be connected to network 10 at any point and the appropriate communication path established logically between the components.

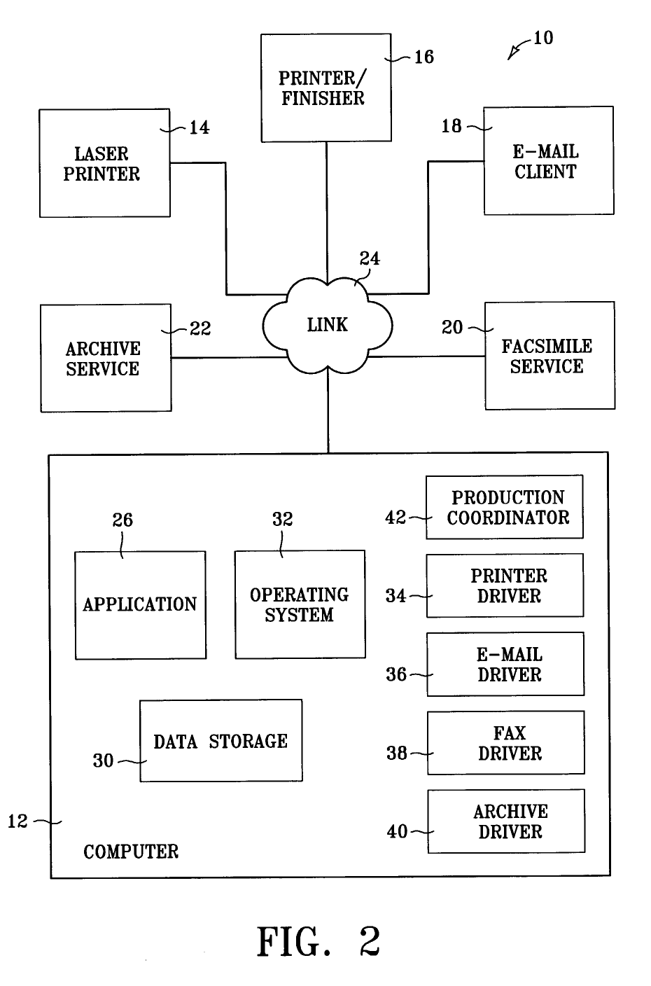

Components: FIG. 2 is a block diagram illustrating the various programming and hardware elements of a document production system implemented in network 10 of FIG. 1. In this example, server 18 functions as an e-mail client operable to deliver a electronic document to a selected e-mail address. Server 20 functions as a facsimile service operable to transmit an electronic document over telecommunication lines to a selected recipient. Server 22 functions as an archive service operable to electronically store a copy of an electronic document in a selected location. It is important to note that these functions provided by servers 18-22 could also be provided by programming operating on computer 12.

Computer 12 includes application 26, data storage 30, and operating system 32. Application 26 represents generally any programming capable of generating and/or retrieving an electronic document and issuing a production command for that document. Data storage 30 represents generally any memory to contain electronic documents. Operating system 32 represents generally any software platform on top of which application 26 can run enabling application 26 to access data storage 30 and communicate with other programming operating on or connected to computer 12.

Computer 12 also includes printer driver 34, e-mail driver 36, fax driver 38, archive driver 40, and production coordinator 42. Drivers are programs that control a device or even other programming. A driver acts like a translator between a particular device or programming and applications that use the device or programming. Each device or programming has its own set of specialized commands that only its driver knows. In contrast, most applications access devices or other programming by using generic commands. The driver, therefore, accepts generic commands from an application and then translates them into specialized commands for the particular device or programming. Printer driver 34, then, acts as a translator between application 26 and printer 14 as well as printer/finisher 16. E-mail driver 36 acts as a translator between application 26 and the e-mail client operating on server 18. Fax driver 38 acts as a translator between application 26 and the facsimile software operating on server 20, while archive driver 40 acts as a translator between application 26 and the archive service operating on server 22.

Production coordinator 42 represents generally any programming capable of receiving a production command from application 26 and communicating with drivers 34-40 to generate an interface enabling a user to select a primary production service, a copy production service, and production options for each. A primary production service is a production service selected by the user to produce a document for an intended purpose. For example, a primary production service may be printer 14 which is instructed to print a letter to be mailed. A copy production service is a production service responsible for producing a document for record keeping purposes. For example, the archive service provided by server 22 may be selected as a copy production service. The archive service may include programming capable of “electronically” printing a document to a specified electronic file format such as PDF (Portable Document Format) and saving the resulting file in a specified location.

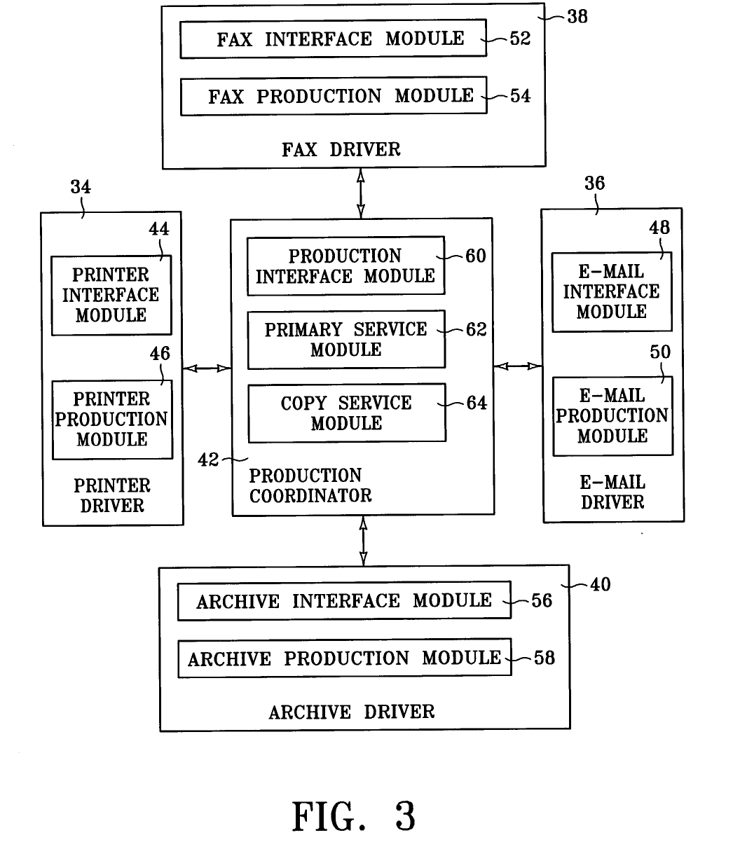

FIG. 3 is a block diagram illustrating the logical program elements of drivers 34-40 and production coordinator 42. Printer driver 34 includes printer interface module 44 and printer production module 46. E-mail driver 36 includes e-mail interface module 48 and e-mail production module 50. Similarly, fax driver 38 and archive driver 40 include, respectively, fax interface module 52, fax production module 54, archive interface module 56, and archive production module 58. Each interface module 44, 48, 52, or 56 for a given driver 34, 36, 38, or 40 represents generally any programming capable of generating or providing an interface for selecting production options for the particular production service associated with that driver 34, 36, 38, or 40. Production options for a printer might include duplexing or color printing. Production options for an archive service might include specifying a particular file format and/or storage location.

Each production module 46, 50, 54, or 58 for a given driver 34, 36, 38, or 40 represents generally any programming capable of translating, according to selected or default production options and instructions from application 26 to produce an electronic document into specialized instructions and delivering the translated instructions to the particular production service associated with that driver 34, 36, 38, or 40.

Production coordinator 42 includes production interface module 60, primary service module 62, and copy service module 64. Production interface module 60 represents generally any programming capable of communicating with drivers 34-40 to generate an interface enabling a user to select a primary production service, a copy production service, and production options for each. Primary service module 62 represents generally any programming capable of setting default production options for a selected primary production service and directing instructions from application 26 to produce an electronic document along with any user selected production options to the driver 34, 36, 38, or 40 for the selected primary production service. Copy service module 64 represents generally any programming capable of setting default production options for a selected copy production service and directing instructions from application 26 to produce an electronic document along with any user selected production options to the driver 34, 36, 38, or 40 for the selected copy production service. It is expected that copy service module 64 will be capable of setting default production options for the selected copy production service that differ from production options for the selected primary production service. For example, where the selected primary and copy production services are both printers, copy service module 64 may automatically set production options for the copy production service that will cause the printed document to have a watermark indicating that it is a copy for the user's records. Consequently, the printed documents produced by the selected printers will differ visually.

The block diagrams of FIGS. 2 and 3 show the architecture, functionality, and operation of one implementation of the present invention. If embodied in software, each block may represent a module, segment, or portion of code that comprises one or more executable instructions to implement the specified logical function(s). If embodied in hardware, each block may represent a circuit or a number of interconnected circuits to implement the specified logical function(s).

Also, the present invention can be embodied in any computer-readable medium for use by or in connection with an instruction execution system such as a computer/processor based system or other system that can fetch or obtain the logic from the computer-readable medium and execute the instructions contained therein. A “computer-readable medium” can be any medium that contains, stores, or maintains programming for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, a portable magnetic computer diskette such as floppy diskettes or hard drives, a random access memory (RAM), a read-only memory (ROM), an erasable programmable read-only memory, or a portable compact disc.

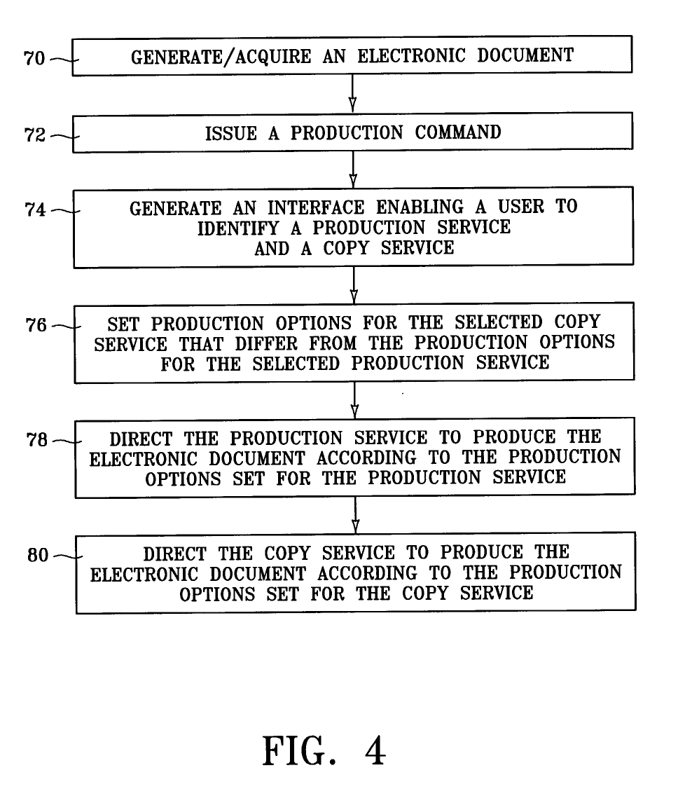

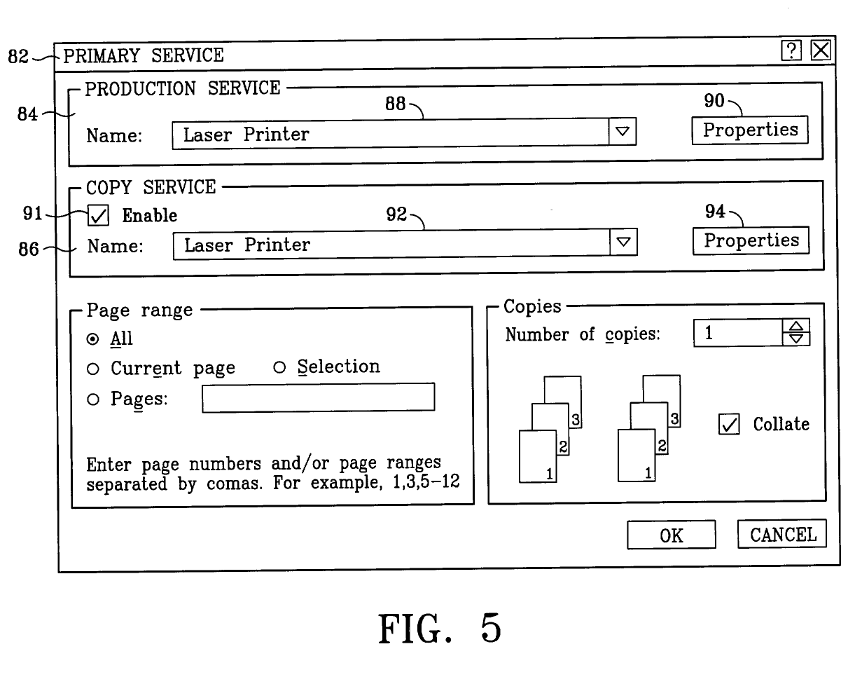

Operation: The operation of one embodiment the present invention will be described with reference to the flow diagram of FIG. 4 and the exemplary screen views of FIGS. 5-10. FIG. 4 illustrates steps taken to produce a document while FIGS. 5-10 illustrate a series of interfaces enabling a user to select a primary production service, a copy production service, and production options for each.

Referring first to FIG. 4, application 26 generates or acquires and electronic document (step 70). Application 26 issues a production command (step 72). Production coordinator 42 receives the request and communicates with drivers 34-40 to generate an interface enabling a user to select a primary production service, a copy production service, and production options for each (step 74). Through the interface, a user selects a primary production service and a copy production service. The two may be the same or different production services. The user may select production options for the selected primary production service. Otherwise, production coordinator 42 selects default production options for the selected primary production service.

Next, production coordinator 42 sets production options for the selected copy production service that differ from production options for the selected primary production service (step 76). For example, the production options for the copy production service may include instructions to add a watermark indicating that the produced document is a copy for the user's records. Alternatively, where the selected copy production service is a printer with multiple input trays, production options selected or set for that service may include instructions to use paper from a particular tray. The paper in the particular tray may, for example, have a unique color enabling a user to easily identify the printed document as a copy for the user's records. It is preferable that the production options set for the copy production service cause the copy production service to produce the document such that the document differs visually from the same document produced by the primary production service. Alternatively, the production coordinator 42 selects default production options for the copy production service if the user doesn't explicitly specify any. The default primary and copy production services as well as default options for each can be specified by the user through the production interface module 60.

The driver 34, 36, 38, or 40, for the selected primary production service, utilizing the production options set for the primary production service, directs the primary production service to produce the electronic document (step 78). The driver 34, 36, 38, or 40, for the selected copy production service, utilizing the production options set for the copy production service, directs the copy production service to produce the electronic document (step 80).

FIG. 5 illustrates a screen view of a production interface 82 generated in step 74. Production interface 82 includes primary service controls 84, and copy service controls 86. Primary service controls 84 include pull down menu 88 enabling a user to select a particular production service and properties command button 90, which, when selected, opens another interface enabling a user to set production options. Copy service controls 86 include enable check box 91, pull down menu 92 enabling a user to select a particular production service and properties command button 94, which, when selected, opens another interface enabling a user to set production options. Where the user does not select enable check box 91, the document will only be produced by the production service identified in pull down menu 88. Production interface 82 may, for example, include other controls for producing selected pages and setting the number of copies. Selections made using those additional controls will be used by the primary production service and, if enabled, the copy production service.

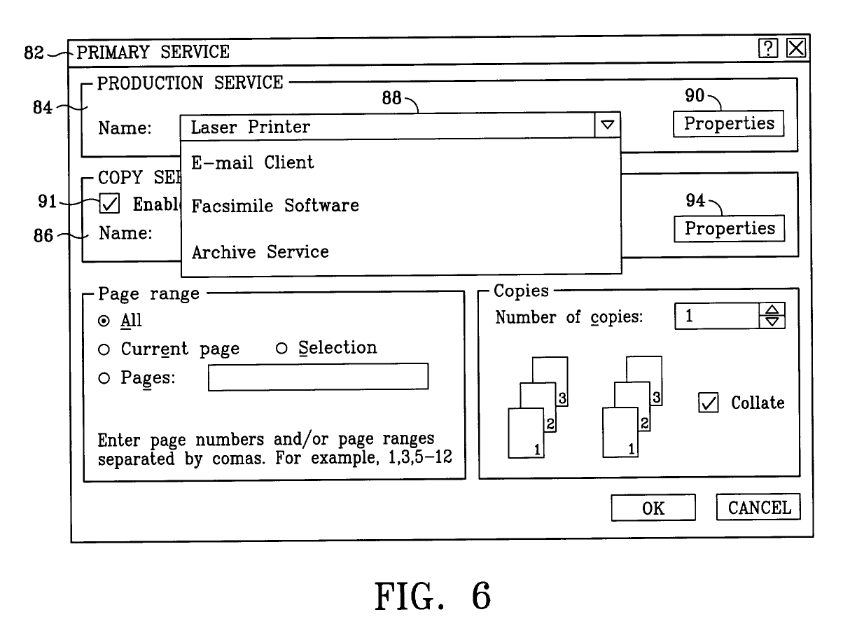

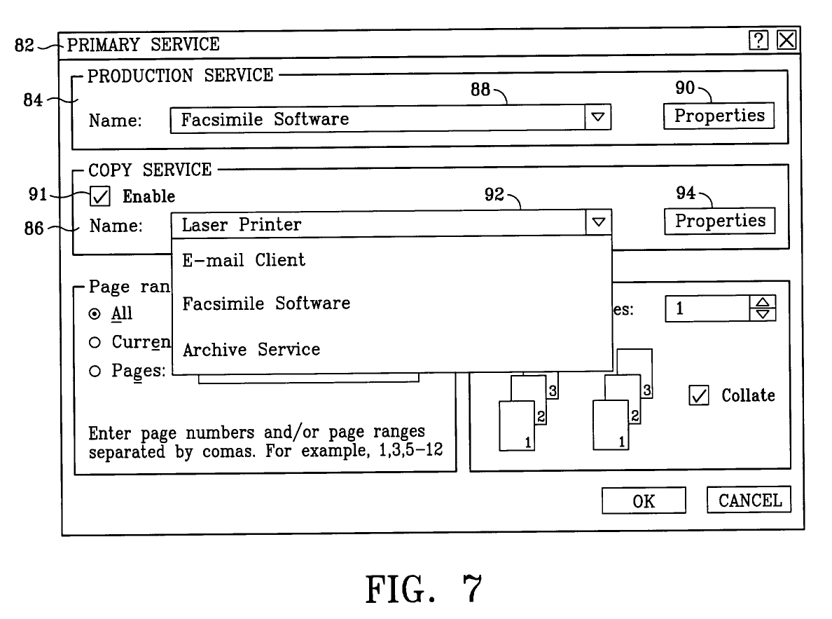

FIG. 6 illustrates production interface 82 after a user has chosen pull down menu 88 for selecting a primary production device. Referring now to FIG. 7, the user selects “Facsimile software” as the primary production service. FIG. 7 also illustrates production interface 82 after a user has chosen pull down menu 92 for selecting a copy production device. Here, the user selects “Laser Printer” as the copy production device.

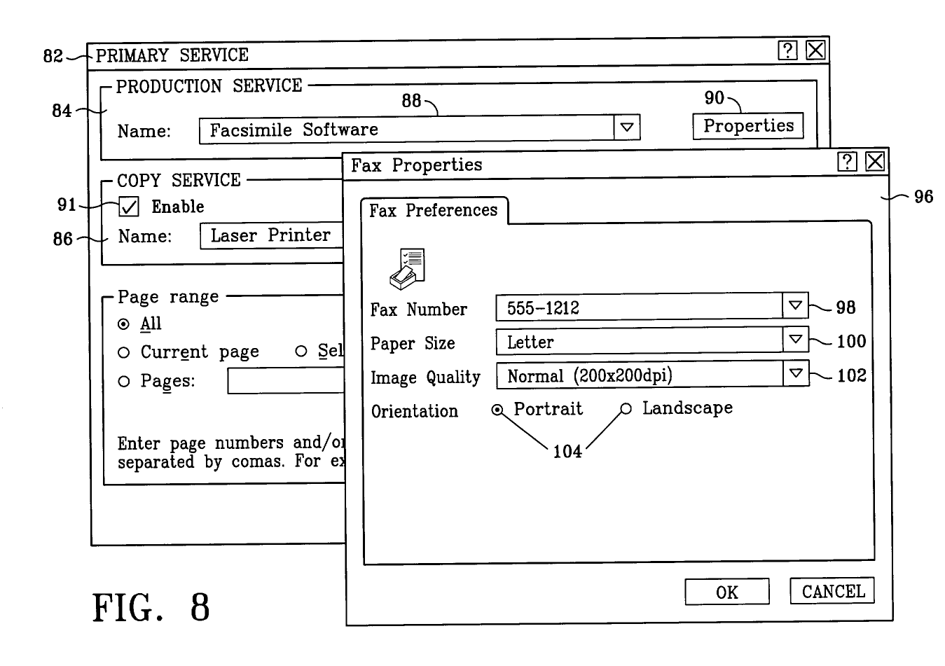

FIG. 8 illustrates a screen view of an interface 96 for selecting production options for facsimile software—in this case—the selected primary production service. Interface 96 is displayed after the user selects command button 90 shown in FIG. 6. Interface 96 includes control 98 for selecting or entering a fax number, control 100 for selecting a paper size, control 102 for selecting a resolution, and controls 104 for setting orientation.

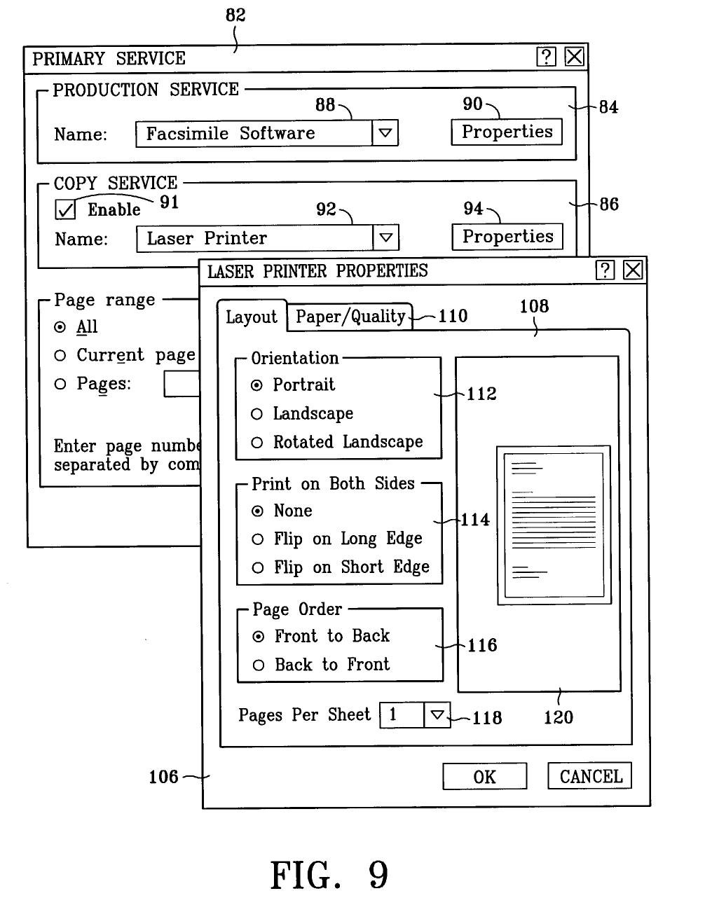

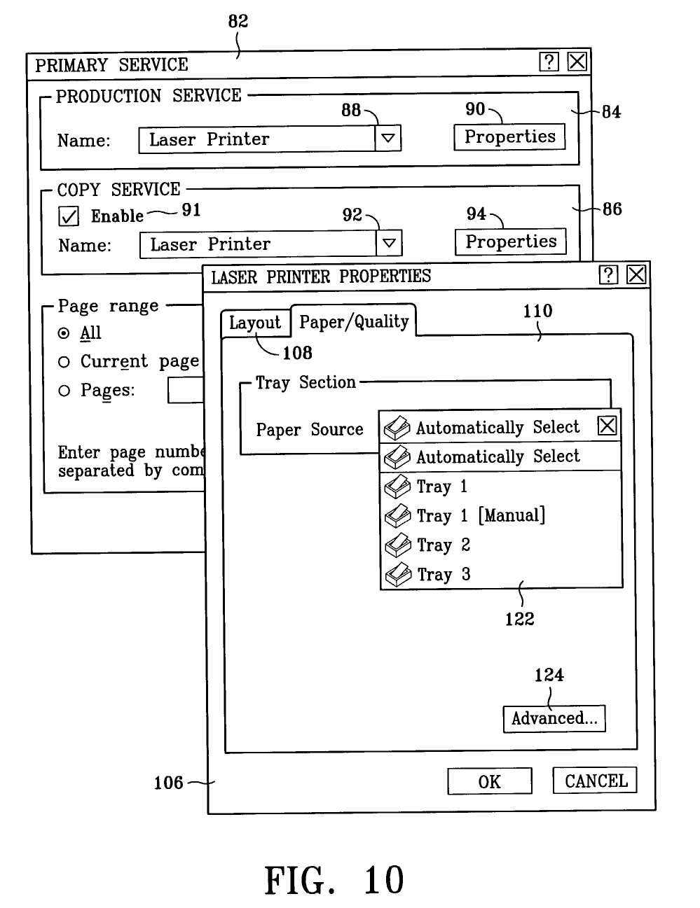

FIG. 9 illustrates a screen view of an interface 106 for selecting production options for a laser printer—in this case—the selected copy production service. Interface 106 is displayed after the user selects command button 94 shown in FIG. 7. Interface 106 includes layout tab 108 and paper/quality tab 110. In this view, layout tab 108 is selected displaying controls 112-118 for setting production options relating to orientation, duplexing, page order, and pages per sheet. Also displayed is document preview pane 120. FIG. 10 illustrates interface 106 with paper/quality tab 110 selected displaying controls 122 and 124 for selecting a paper input tray and selecting advanced production options.

Although the flow chart of FIG. 4 shows a specific order of execution, the order of execution may differ from that which is depicted. For example, the order of execution of two or more blocks may be scrambled relative to the order shown. Also, two or more blocks shown in succession in FIG. 4 may be executed concurrently or with partial concurrence. All such variations are within the scope of the present invention. The screen displays of FIGS. 5-10 are exemplary only. There exist many possible layout and control configurations for interfaces that will allow a user to select primary and copy production services and production options for each.

The present invention has been shown and described with reference to the foregoing exemplary embodiments. It is to be understood, however, that other forms, details, and embodiments may be made without departing from the spirit and scope of the invention, which is defined in the following claims.

What is claimed is:

1. A document production method comprising:
receiving a command to produce a document;
setting production options for a copy production service that differ from the production options for a primary production service;
directing the primary production service to produce the document according to the production options set for the primary production service; and
directing the copy production service to produce the document according to the production options set for the copy production service.

2. The method of claim 1, wherein the copy production service and the primary production service are the same production service.

3. The method of claim 1, wherein setting production options for a copy production service comprises setting production options that will cause the copy production service to produce the document such that the document produced by the copy production service will differ visually from the same document produced by the primary production service.

4. The method of claim 3, wherein setting production options for the copy production service comprises setting production options that will cause the copy production service to add a water mark such that the document produced by the copy production service will differ visually from the same document produced by the primary production service.

5. The method of claim 3, wherein the primary and copy production services are printing devices and wherein setting production options for the copy production service comprises setting production options that will cause the copy production service to print the document on a first media, and wherein the production options set for the primary production device will cause the primary production service to print the document on a second media that differs visually from the first media.

6. The method of claim 5, wherein the copy production service and the primary production service are the same printing service.

7. A document production method, comprising:
receiving a command to produce a document;
generating a user interface enabling a user to select a primary production service and a copy production service;
setting production options for a selected copy production service that differ from the production options for a selected primary production service;
directing the selected primary production service to produce the document according to the production options set for the primary production service; and
directing the selected copy production service to produce the document according to the production options set for the copy production service.

8. The method of claim 7, wherein the copy production service and the primary production service are the same production service.

9. The method of claim 7, wherein setting production options for a selected copy production service comprises setting production options that will cause the copy production service to produce the document such that the document produced by the copy production service will differ visually from the same document produced by the primary production service.

10. A document production method, comprising:
receiving a command to produce a document;
generating a user interface enabling a user to select a primary production service, to enable copy production, and to select a copy production service;
directing the selected primary production service to produce the document according to production options set for the primary production service; and
where copy production has been enabled through the user interface, setting production options for a selected copy production service that differ from the production options for the selected primary production service, and directing the selected copy production service to produce the document according to the production options set for the copy production service.

11. The method of claim 10, wherein the copy production service and the primary production service are the same production service.

12. The method of claim 10, wherein setting production options for a selected copy production service comprises setting production options that will cause the copy production service to produce the document such that the document produced by the copy production service will differ visually from the same document produced by the primary production service.

13. A document production method, comprising:
issuing a command to produce a selected document;
generating a user interface enabling a user to select a primary production service, to enable copy production, and to select a copy production service;
through selections made by a user through the interface, selecting a primary production device, selecting production options for the primary production device, and selecting a copy production device;
setting production options for the selected copy production service that differ from the production options for the selected primary production service;
directing the selected primary production service to produce the document according to the production options set for the primary production service; and
directing the selected copy production service to produce the document according to the production options set for the copy production service.

14. The method of claim 13, wherein the copy production service and the primary production service are the same production service.

15. The method of claim 13, wherein setting production options for the selected copy production service comprises setting production options that will cause the copy production service to produce the document such that the document produced by the copy production service will differ visually from the same document produced by the primary production service.

16. A computer readable medium having instructions for:
receiving a command to produce a document;
setting production options for a copy production service that differ from the production options for a primary production service;
directing the primary production service to produce the document according to the production options set for the primary production service; and
directing the copy production service to produce the document according to the production options set for the copy production service.

17. The medium of claim 16, wherein the copy production service and the primary production service are the same production service.

18. The medium of claim 16, wherein the instructions for setting production options for a copy production service comprise instructions for setting production options that will cause the copy production service to produce the document such that the document produced by the copy production service will differ visually from the same document produced by the primary production service.

19. The medium of claim 18, wherein the instructions for setting production options for the copy production service comprise instructions for setting production options that will cause the copy production service to add a water mark such that the document produced by the copy production service will differ visually from the same document produced by the primary production service.

20. The medium of claim 18, wherein the primary and copy production services are printing devices and wherein the instructions for setting production options for the copy production service comprise instructions for setting production options that will cause the copy production service to print the document on a first media, and wherein the production options set for the primary production device will cause the primary production service to print the document on a second media that differs visually from the first media.

21. The medium of claim 20, wherein the copy production service and the primary production service are the same printing service.

22. A computer readable medium, having instructions for:
receiving a command to produce a document;
generating a user interface enabling a user to select a primary production service and a copy production service;
setting production options for a selected copy production service that differ from the production options for a selected primary production service;
directing the selected primary production service to produce the document according to the production options set for the primary production service; and
directing the selected copy production service to produce the document according to the production options set for the copy production service.

23. The medium of claim 22, wherein the copy production service and the primary production service are the same production service.

24. The medium of claim 22, wherein setting production options for a selected copy production service comprise instructions for setting production options that will cause the copy production service to produce the document such that the document produced by the copy production service will differ visually from the same document produced by the primary production service.

25. A computer readable medium, having instructions for:
receiving a command to produce a document;
generating a user interface enabling a user to select a primary production service, to enable copy production, and to select a copy production service;
directing the selected primary production service to produce the document according to production options set for the primary production service; and
where copy production has been enabled through the user interface, setting production options for a selected copy production service that differ from the production options for the selected primary production service, and directing the selected copy production service to produce the document according to the production options set for the copy production service.

26. The medium of claim 25, wherein the copy production service and the primary production service are the same production service.

27. The medium of claim 25, wherein the instructions for setting production options for a selected copy production service comprise instructions for setting production options that will cause the copy production service to produce the document such that the document produced by the copy production service will differ visually from the same document produced by the primary production service.

28. A computer readable medium, having instructions for:
issuing a command to produce a selected document;
generating a user interface enabling a user to select a primary production service, to enable copy production, and to select a copy production service;
through selections made by a user through the interface, selecting a primary production device, selecting production options for the primary production device, and selecting a copy production device;
setting production options for the selected copy production service that differ from the production options for the selected primary production service;
directing the selected primary production service to produce the document according to the production options set for the primary production service; and
directing the selected copy production service to produce the document according to the production options set for the copy production service.

29. The medium of claim 28, wherein the copy production service and the primary production service are the same production service.

30. The medium of claim 28, wherein the instructions for setting production options for the selected copy production service comprise instructions for setting production options that will cause the copy production service to produce the document such that the document produced by the copy production service will differ visually from the same document produced by the primary production service.

31. A document production system, comprising:
one or more production services;
an application operable to issue a command to produce a document; and
a production coordinator operable to receive the a command to produce a document from the application, to generate a user interface enabling a user to select one of the one or more production services as a primary production service, to select one of the one or more production services as a copy production service, and to set production options for a selected copy production service that differ from production options set for a selected primary production service.

32. The system of claim 31, wherein the production coordinator is further operable to set production options that will cause the copy production service to produce a document such that the document produced by the copy production service will differ visually from the same document produced by the primary production service.

33. The system of claim 31, wherein the production coordinator is further operable to set production options that will cause the copy production service to add a water mark such that the document produced by the copy production service will differ visually from the same document produced by the primary production service.

34. The system of claim 31, wherein the selected copy production service and the selected primary production service are the same printing service and wherein the production coordinator is further operable to set production options that will cause the copy production service to print the document on a first media, and wherein the production options set for the primary production device will cause the primary production service to print the document on a second media that differs visually from the first media.

35. The system of claim 31, wherein the production coordinator includes:
a production interface module operable to generate the interface;
a primary service module operable to communicate with a driver for the selected primary production service to set production options for the selected primary production service and to direct production of the document by the selected primary production service; and
a copy service module operable to communicate with the primary service module and a driver for the selected copy production to set productions options for the selected copy production service that differ from copy production options set for the primary production service and to direct production of the document by the selected copy production service.

36. A document production system, comprising:
one or more production services each associated with a driver;
a means for issuing a command to produce a document;
a means for receiving a command to produce a document from the application and to generate a user interface enabling a user to select one of the one or more production services as a primary production service, to select one of the one or more production services as a copy production service;
a means for setting production options for the selected primary production service and for directing production of the document by the selected primary production service; and
a means for setting production options for the selected copy production service that differ from copy production options set for the primary production service and for directing production of the document by the selected copy production service.
